(19) United States
(12) Patent Application Publication
(10) Pub. No.: US 2004/0156198 A1
(43) Pub. Date: Aug. 12, 2004

(54) Non-coppered base lamp and its holder

(76) Inventor: Chiu-Chin Chen, Hsinchu City (TW)

Correspondence Address: CHARLES E. BAXLEY, ESQUIRE, Fifth Floor, 59 John Street, New York, NY, 10038, US

(21) Appl. No.: 10/364,950

(22) Filed: Feb. 12, 2003

(51) Int. Cl. H01R 33/00

(52) U.S. Cl. 362/226

(57) ABSTRACT

The present invention provides a non-copper base lamp and its holder, in which the lamp is composed of the glass bulb and plastic base combined together matching on holder by locking a dowel pin set on the bottom end of said plastic base on a socket of said holder, instead of the conventional coppered threaded base screwing on the threaded socket of the conventional holder. For preventing the bulb from turning relatively to the plastic base to occur short circuit happening on the heater leads, the lamp has a locking device set upon the bottom side of the bulb and the top side of said base by embedding together tightly for avoiding them relatively turning. On the other side, every pin hole is pre-set two conducting strip slots exactly above the two power cords individually, so that the user can set it in serial or parallel connection by any will.

### BACKGROUND OF THE INVENTION

1. Field of the Invention

The present invention relates to a decoration lamp structure including lamp and lamp-holder, and more particularly to a non-coppered base lamp and its holder.

2. Description of Prior Art

In accordance with the conventional decoration string lamps with required certain brightness, most of them are typically smaller watt common coppered base lamps (but not Christmas lamps). For a so long time this structure has not changed yet, so that the matched lamp-holder has never changed too. Referring to FIG. 5, it is shown that a newer lamp 91 and it holder 92 in the market so far. Said lamp 91 has a threaded coppered base 911 at the bottom end, and a conduction terminal 912 held at the bottom tip-end; coordinating to it, said lamp-holder 92 has a threaded socket 921 geared with the thread of said coppered base 911, and two conducting strips 922 set upon the lower positions with a sharp tip 923 respectively; when the cords 93 are put into the cover 94, and the lamp-holder 92 is compelled to sit on said cover 94 for locking, said conducting strips 922 are piercing the insulation cover of the cords 93 respectively with said sharp tips 923 to form conduction state. In practicing, just need to screw the lamp 91 on the lamp-holder 92 with said coppered base 911, the both conducting strips 922 respectively contact with said coppered base 911 and the conduction terminal 912 to form conduction loop to light the lamp 91.

But the conventional product has following shortcomings:

1. the common lamp using copper material not only has higher production cost, but also a shorter service life especially under lighting for a longer time or flashing continuously controlled in sequence control so that the lamps are often needed to be replaced. Therefore the consumers have to increase their purchase money; and when recovering the wasted copper material, the processing is easy to pollute the environment imperceptibly to increase the society cost.

2. depending on the current arrangement of the decoration lamp string, the connection method is in serial or parallel connection, but the conventional product can not be changed the positions locating said two conducting strips in design, so that a serial connection lamp-holder is just used in serial connection, but not used in parallel connection, hence the vender has to prepare two set of casting molds for facilitating manufacturing the both different lamp-holder, and meanwhile to prepare two set of components for assembling, it not only takes more time and labor in manufacture management, but also increases casting mold and preparing double assessments cost in manufacturing.

### OBJECTS AND SUMMARY OF THE INVENTION

It is therefore a main object of the present invention to provide a non-coppered base lamp and its holder, in which the lamp is composed of glass bulb and plastic base for reducing the production cost and environment pollution.

Another object of the present invention is to provide a non-coppered base lamp and its holder, in which said lamp-holder can be used in serial or parallel connection, so that the production cost is efficiently reduced and increased single product extra value.

These objects are achieved by a non-coppered base lamp and its holder, in which the lamp is composed of the glass bulb and plastic base combined together matching on holder by locking a dowel pin set on the bottom end of said plastic base on a socket of said holder, instead of the conventional coppered threaded base screwing on the threaded socket of the conventional holder. For preventing the bulb from turning relatively to the plastic base to occur short circuit happening on the heater leads, the lamp has a locking device set upon the bottom side of the bulb and the top side of said base by embedding together tightly for avoiding them relatively turning. On the other side, every pin hole is pre-set two conducting strip slots exactly above the two power cords individually, so that the user can set it in serial or parallel connection by any will.

### BRIEF DESCRIPTION OF THE DRAWINGS

FIG. 1 is an exploded solid view of the present invention.

FIG. 1a is an enlarged view showing the pinhole of the present invention.

FIG. 2 is a topside view of the present invention.

FIG. 3 is a sectional view showing the 3-3 section of FIG. 2.

FIG. 4 is a sectional view showing the 4-4 section of FIG. 2.

FIG. 5 is a solid view of prior art.

### DETAILED DESCRIPTION OF PREFERRED EMBODIMENTS

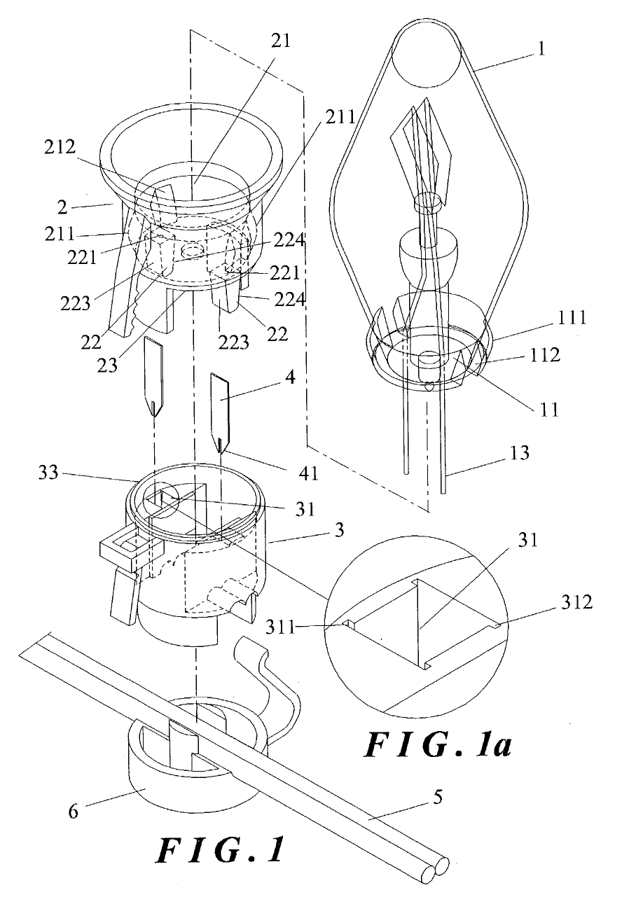

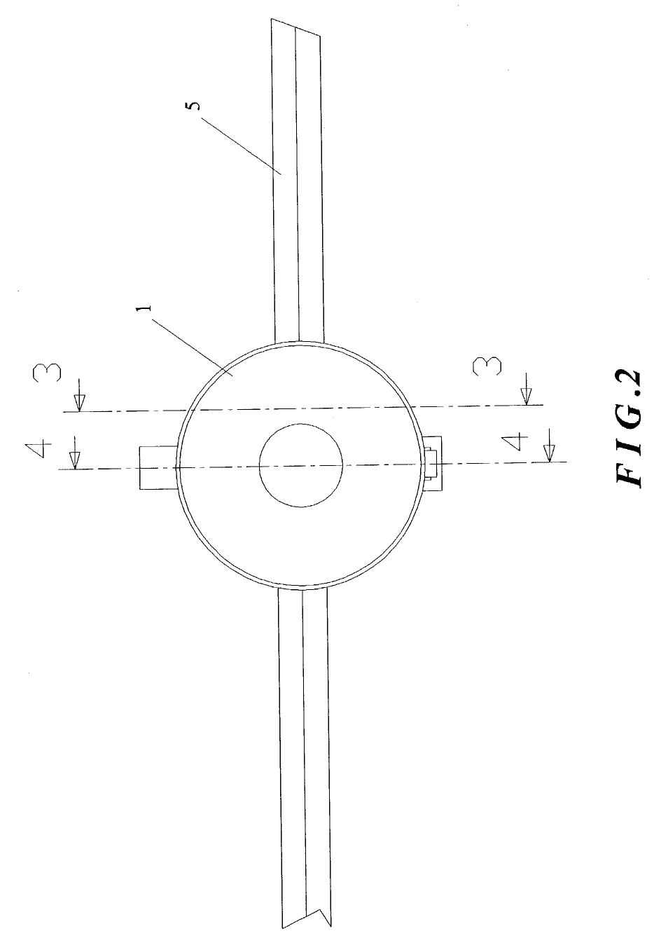

Referring to FIG. 1, the glass bulb 1 extends a locking device 11 at the bottom side, which is a non-circular block in level section, and two retaining grooves 112 set upon the opposite sides, and surrounding said block a lug 111 built upon for locking; a plastic base 2 is shaped into a cylinder having a housing 21 on the top side matching to said locking device 11, and coordinating to said retaining grooves 112 two ribbed lugs 212 built upon the proper positions, and recesses 211 coordinating to said lug 111; and there are two pins 22 extended downward at the bottom side, in each pin 22 at least a pair of opposite flats 223 224 are built on the outside wall, the both pins 22's flats should be kept in coordinating side; for leading the heater leads of the bulb from the housing 211 to the outside via said pins 22, there are two through fine holes 221 built upon the pins 22 separately.

In combining, sit said glass bulb 1 into said plastic base 2 by catching said locking device 11 at said housing 21, just such as respectively said retaining grooves 112 holding said ribbed lugs 212, said lugs 111 locking on said recesses 211 tightly, so that the two components joint together tightly without any relative turning, meanwhile the two heater leads 13 is wired out from said fine holes 221 and bended up close contacting the outside flat 223 or 224 surfaces of said pins 22 respectively for using.

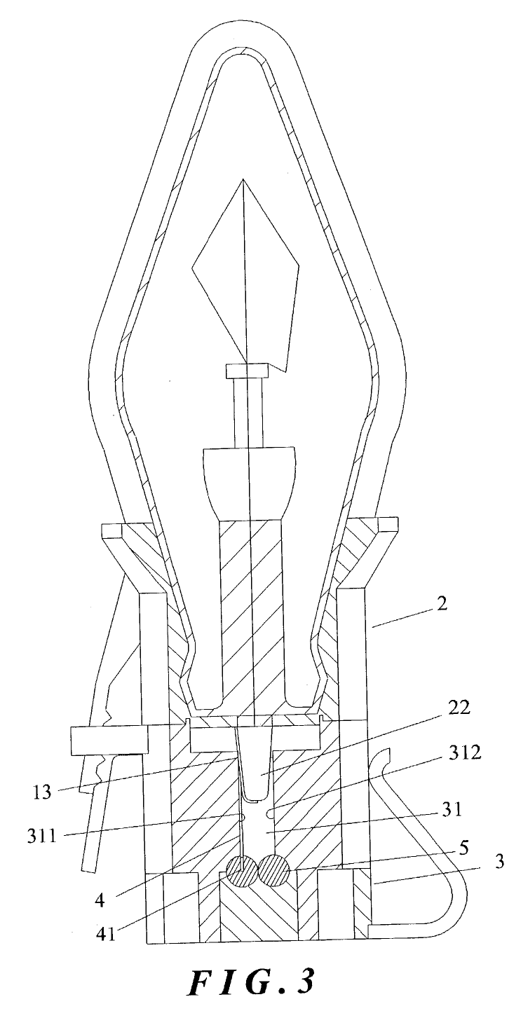

A lamp-holder 3 is shaped in cylinder having two pin holes 31 at the proper positions coordinating to said pins 22 on the top side passing through the body of said holder 3, the inner sides coordinating to flats 223 or 224 of said pins 22 are pre-built a pair of said conducting strip slots 311 312 (as shown in FIG. 1a) respectively, and each pin hole 31 has two opposite conducting strip slots 311 312 respectively suspending over the two power cords 5, as one slot 311 or 312 is selected for embedding in a conducting strip 4 kept the sharp tip downward, and close a cover 6 on the bottom tightly, said sharp tip 41 will pierce the insulation cover of said power cords 5 out to get the conduction core, thereby conducting said heater leads 13 laid on the outside of said pins 22 to the power cords 5 (as shown in FIG. 3).

Referring to FIG. 1, FIG. 1a and FIG. 3, if said heater leads 13 are separately bend back close contacting on the same side surfaces of the flats 223 or 224 of two pins 22 simultaneously, the conducting strips 4 should be placed in the coordinating slots 311 or 312 of said pin holes 31 respectively so as to keep said heater leads 13 and said conducting strips 4 in the same side for contacting, in this case, said lamp 1 is connected on said power cords 5 in serial connection. If said two heater leads 13 are separately bend up close contacting on the different outside surfaces of the flat 223 224 of said two pins 22, so that the conducting strips 4 are separately embedded into different slots 311 312 of said pin hole 31 to coordinate to the heater leads 13 for keeping the lamp 1 conducting to the power cords.

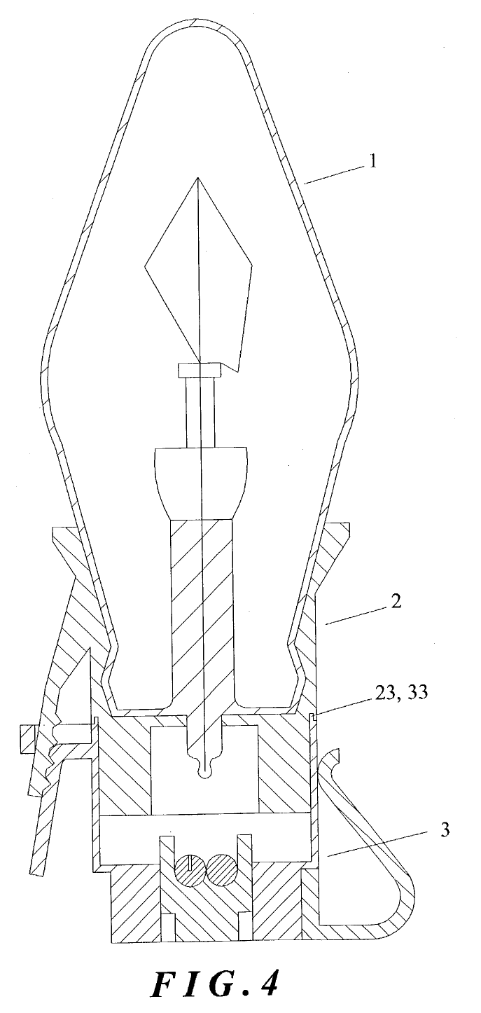

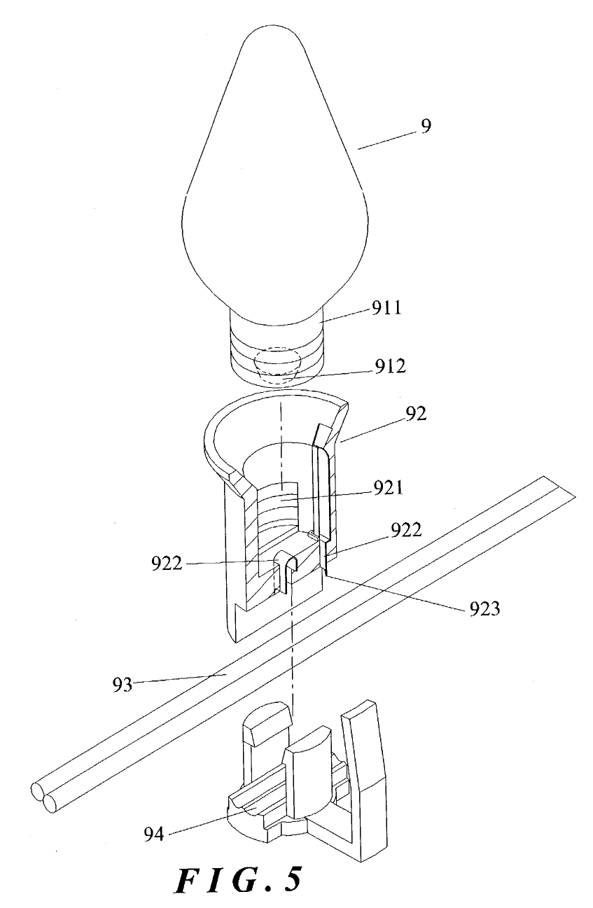

Referring to FIG. 1, FIG. 3 and FIG. 4, a locking device including a circular flange 33 and a ring groove 23 is built up on the bottom side of said bulb base 2 and the topside of said holder 3 separately in proper coordinating positions for providing good waterproof effect.

I claim:

1. a non-coppered base lamp and its holder, wherein a glass bulb extends a locking device at the bottom side, which is a non-circular block in level section, and surrounding said block a lug built upon for locking; a plastic base is shaped into a cylinder having a housing on the top side matching to said locking device, and recesses coordinating to said lug; and there are two pins extended downward at the bottom side, in each pin at least a pair of opposite flats are built on the outside wall, the both flats of said pins should be kept in coordinating side; for leading the heater leads of the bulb from the housing to the outside via said pins, there are two through fine holes built upon the pins separately, thereby locking the bottom portion of said bulb on the housing without any turning move, meanwhile the two heater leads is wired out from said fine holes and bended up close contacting the outside flat surfaces of said pins respectively; a lamp-holder is shaped in cylinder having two pin holes at the proper positions coordinating to said pins on the top side passing through the body of said holder, the inner sides coordinating to flats of said pins are pre-built a pair of said conducting strip slots respectively, and each conducting strip slot respectively suspending over the two power cords, in each pin hole can be set in a conducting strip for connecting the heater lead to the coordinating power cord.

2. a non-coppered base lamp and its holder as claimed in claim 1, wherein a locking device including a circular flange and a ring groove is built up on the bottom side of said bulb base and the top side of said holder separately in proper coordinating positions.

3. a non-coppered base lamp and its holder as claimed in claim 1, wherein a geared ratchet and ratchet bar locking device are separately built upon the proper positions of the outside walls of said plastic base and said lamp-holder.
